(19) United States
(12) Patent Application Publication
(10) Pub. No.: US 2009/0293339 A1
(43) Pub. Date: Dec. 3, 2009

(54) ATHLETIC DEVICE TENSIONER

(76) Inventor: John Bartholomew, Encinitias, CA (US)

Correspondence Address: Joseph Curtis Edmondson, 15490 NW Oak Hills Dr, Beaverton, OR, 97006, US

(21) Appl. No.: 12/473,235

(22) Filed: May 27, 2009

Related U.S. Application Data
(60) Provisional application No. 61/056,698, filed on May 28, 2008.

(51) Int. Cl. A01K 87/00; A63B 53/00; A63B 59/14

(52) U.S. Cl. 43/18.1 R; 74/1 R; 473/316; 473/560

(57) ABSTRACT

An improved athletic device that may be tensioned depending on the use by the individual user is provided. The contemplated athletic device may be any of a plurality of different athletic devices including fishing rods, hockey sticks, golf clubs, lacrosse sticks, and just about any athletic device having a shaft that is advantageous to be able to flex when is use by the end user. The device would have a shaft and a tensioner mechanism anchored within the shaft of the device which may be manually and continuously adjusted by the individual user depending on the flexion desired by the user.

This application claims priority to U.S. Provisional Patent Application 61/056,698 filed on May 28, 2008.

### FIELD OF THE INVENTION

The field of the invention is for athletic devices. More specifically, the field of invention is for a tensioning system for athletic devices where flexion is advantageous.

### BACKGROUND

Athletic games have been around for centuries. Many of these athletic games require the use of equipment such as sticks, poles, shafts, rods and balls. The equipment used from sport to sport differs as does the materials used to construct each of these unique equipment devices.

For example, the sport of pole vaulting requires a pole that is constructed of a suitably rigid material that will maintain and support the weight of the athlete. However, the pole must be constructed to have an extreme amount of flexion thereon to allow the pole to flex, yet not break while in use by the athlete. The materials, rigidity and thickness of the pole is extremely important to make the device work. Therefore, the art of construction of a pole vault pole is extremely sensitive.

Similarly, the sport of hockey utilizes a hockey stick. Prior art hockey sticks were originally constructed of dense wood that was not too susceptible to breaking. The wood was fashioned with a large shaft portion and at least a blade portion. Typically, the shaft and the blade were two different pieces that were glued together or affixed to each other. However, as the game became increasingly competitive and the athletes stronger, wood sticks have a tendency to fracture from stress. Hockey sticks where then fabricated from aluminum resulting in a more rigid stick, but didn't give the flexion that the athlete desired. Some other materials, such as composites like carbon fiber, have also been utilized in the construction of hockey sticks. However, because of the relative thinness of the composites, they are also quite prone to breaking. Additionally, the construction of these types of sticks do not allow for significant adjustment by the user of the desired tension, rigidity and the like.

Similarly, the sport of lacrosse utilizes a lacrosse stick. Prior art lacrosse sticks were originally constructed of wood. The wood was fashioned with a square shaft portion and at least a net portion. Modern lacrosse sticks are typically fabricated from aluminum resulting in a more rigid stick, but didn't give the flexion that the athlete desired. Some other materials, such as composites like carbon fiber, have also been utilized in the construction of lacrosse sticks. However, because of the relative thinness of the composites, they are also quite prone to breaking. Additionally, the construction of these types of sticks do not allow for significant adjustment by the user of the desired tension, rigidity and the like.

Another area that has seen significant development over the years is the sport of fishing. A fishing rod is utilized to catch fish. Typically, the fishing rod is used in combination with a bait and other materials to lure the fish to be caught. The fishing pole can be made of many different types of materials. Traditionally, prior art fishing rods were constructed of wood and had some flexibility to allow the user to guide the fish to be caught. Typically, the rods are light, thin and flexible and may be sized to accommodate the fish being sought and for wind and water conditions that are present at the time the individual user is fishing. More modern rods, such as fly fishing rods are constructed of carbon graphite or graphite fibers. This material is advantageous because it allows considerable flexion without breaking. However, a problem that exists is that the rod is made for very specific purposes including the size of the fish to be caught, specific wind conditions and specific water conditions. Therefore, an individual may need several different rods depending on the needs at the time they go fishing. Therefore, a need exists for an improved athletic device that has a tensioner system therein which may allow for adjustability of the device when desired by the user. Additionally, a need exists for an improved athletic device that may increase and/or decrease the flexion of the device relative to the force being exerted on the device by the user. Moreover, a need exists for an improved athletic device which may be adjustable depending on the tension required by the user.

### SUMMARY OF THE INVENTION

The present invention provides an improved athletic device that may be tensioned depending on the use by the individual user. The contemplated athletic device may be any of a plurality of different athletic devices including fishing rods, hockey sticks, golf clubs and just about any athletic device having a shaft that is able to flex. The device would have a shaft and a tensioner device enclosed within the device which may be adjusted by the individual user depending on the flexion desired by the user.

Among the many different possibilities contemplated, the device facilitates tensioning of the shaft of an athletic apparatus.

Additionally, in an exemplary embodiment, the device may be utilized to tension the flexion of the device by the individual user.

In yet another exemplary embodiment, it is contemplated that the athletic tensioner device may be used in the shaft of the device.

In another exemplary embodiment, it is contemplated that the tensioner device may have an adjustment mechanism thereon for adjustment of tensioning of the device when in use.

A further exemplary embodiment contemplates that the tensioner device may be adapted for use with a fishing rod.

In yet another exemplary embodiment, the tensioner device may be adapted for use in association with a hockey stick.

Additionally, in an exemplary embodiment, the tensioner device may be adapted for use in a golf club.

In yet another exemplary embodiment of the present invention, the tensioner device may be adapted for use in any athletic device having a shaft whereby it is advantageous for the shaft of the device to flex.

Still another exemplary embodiment of the present invention is to provide a tensioner device which may be adapted for use in an athletic device whereby the tensioner may extend from a first portion of the device to a second portion of the device and may have an adjustment mechanism on the outside of the device to allow for tensioning of the tension mechanism inside the device.

Yet another exemplary embodiment of the present invention is to provide a tensioner device which may be adapted for use in a plurality of different athletic devices.

Still another exemplary embodiment is to provide a tensioner device whereby the tension mechanism may be constructed of polyethylene.

Another exemplary embodiment of the invention is to provide a tensioner device whereby the tension mechanism may be constructed of rubber.

The tensioner device may be constructed of plastic, metal or any other material which allows for in yet another exemplary embodiment.

A further exemplary embodiment is to provide a tensioner device whereby the tension mechanism may be completely contained within the shaft of an athletic device.

Another exemplary embodiment is to provide a tensioner device whereby the tension mechanism may be anchored to a first portion of the interior of the device and a second portion of the interior of the device.

Also claimed and described is an athletic apparatus, the apparatus having a shaft portion having an interior portion and at least a first end and a second end; a tensioner adapted for attachment to the first end and the second end; and an adjustment mechanism on the exterior portion of the apparatus. The apparatus also having an adjustment mechanism changes the flexion of the shaft relative to the tensioner. The apparatus also having an adjustment mechanism allows for increased tension on the tensioner mechanism. The apparatus described is a golf club The apparatus is a hockey stick. The apparatus is a fishing pole. The apparatus also having a shaft has an interior portion and the interior portion is hollow allowing for adaption of the tensioner mechanism therein. The apparatus also having a tensioner mechanism constructed of polyethylene. The apparatus also has a shaft portion flexion adjustable relative to the tensioner mechanism rigidity. The apparatus also having a shaft portion that is flexible and whereby the tensioner mechanism increases and/or decreases the flexibility and flexion of the entire apparatus by adjustment of the individual end user.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a side view of the device tensioner.

FIG. 2 is a side view of one embodiment of the device tensioner in a fishing rod.

### DETAILED DESCRIPTION

While describing the invention and its embodiments various terms will be used for the sake of clarity. These terms are intended to not only include the recited embodiments, but also all equivalents that perform substantially the same function, in substantially the same manner to achieve the same result.

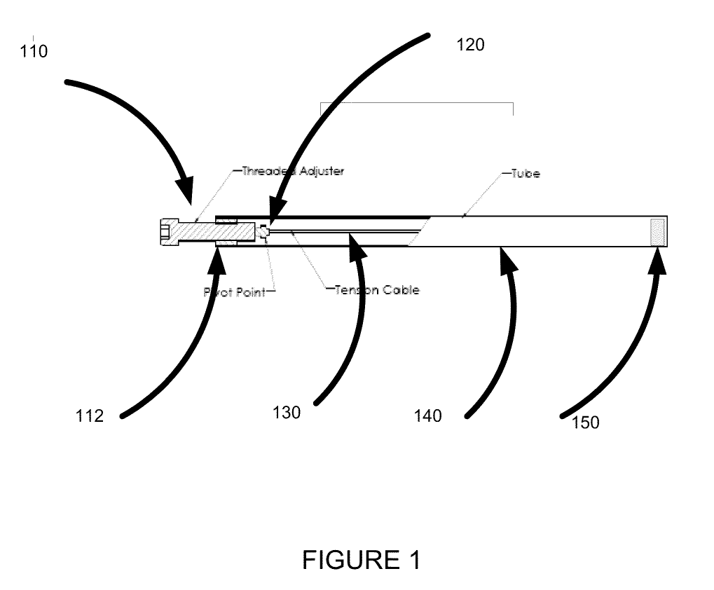

Now referring to FIG. 1. The cut-away view of the device tensioner is shown with an adjuster 110, a threaded shaft in which the adjuster 110 is inserted 112, a pivot point that is attached to the adjuster 110. A tension member 130 is threaded inside the composite tube 140 and is terminated on an inserted disk 150 that is affixed to the tension member 130. When the adjuster 110 is rotated in one direction, it moves outwards and likewise the opposite movement causes the adjuster 130 to move inwards. Outward adjustment of the adjuster exerts a tensile force on the tension member 130, which is then exerted on the composite tube 140 via the inserted disk 150. The additional force causes the tube 140 to become more rigid.

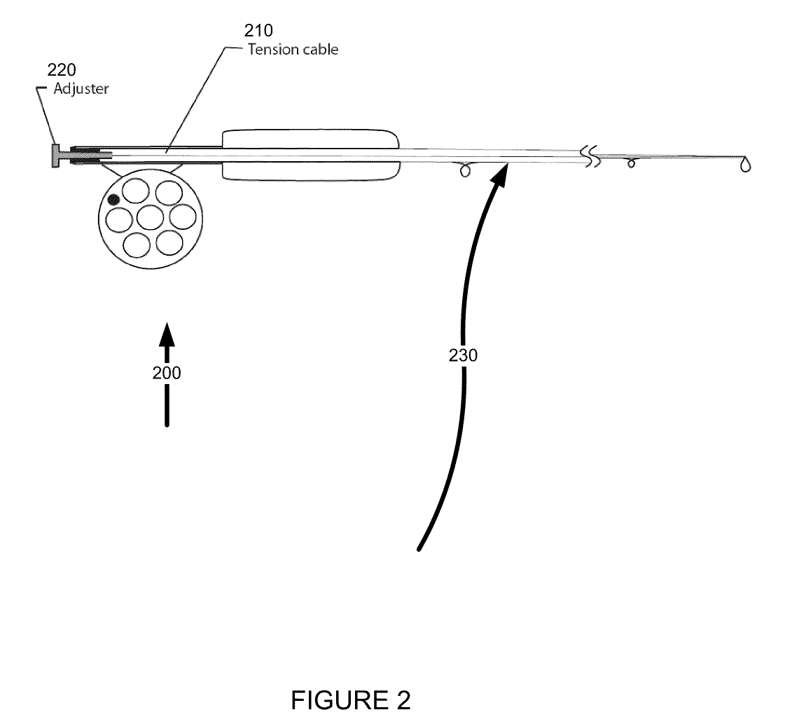

Now referring to FIG. 2 which depicts a side view of the tensioning system as it applies to a fishing rod 200.

A traditional modern fishing rod is made up of a hollow tapered composite tube 230. Guides are attached to the exterior to support the fishing line. The casting properties of the rod are determined by the taper parameters and thickness and stiffness of the final materials. However, once the rod is finished it flexural properties will remain unchanged over the life of the rod.

The adjustable system adds a tension member into the center of the hollow tube. The tension member reaches from a point at the tip or in the upper portion of the rod to its butt end. At the butt end the tension member, which can be either a braided cord or semi-rigid rod, is connected to an rod adjustable screw 220 or other adjusting mechanism. The rod adjustable screw 220 mechanism is used to vary the tension on rod tension member 210. By applying a tensile force to therod tension member 210 and equal and opposite compressive force results on the main rod body and on the rod composite tube 230. This force causes pretensioning of the composite fibers within the rod composite tube 230. The pretension of fiber results in a stiffening of the rod composite tube 230 wall. The effect is to causing the rod to stiffen which in turn changes the casting performance of the fishing rod.

The rod tension member 210 may be affixed internally to the composite tube in a number of ways. For example, the rod tension member 210 may be connected by an internal disk (not shown) that is placed at an interval along the tube. Alternately, the rod tension member 210 may be flared out and affixed in a radial fashion to the rod composite tube 230.

The rod body may be made of a laminate composite with a mixture of epoxy and carbon fiber, fiberglass, kevlar, and/or boron fibers.

In one embodiment of the rod tension member 210 may be made of a braided cord made of Vectran, Spectra or Kevlar or it could be a solid rod of axially place carbon fibers.

The rod tension member 210 may be rigid in addition to being a flexible cord. Rigidity may be in the form of a pliable rod where tension placed.

While the embodiments of the invention have been described in detail and shown in the accompanying drawing, it will be evident that various further modifications are possible without departing from the scope of the invention as set forth in the following claims.

I claim:

1. An athletic apparatus, the apparatus comprising:
a shaft portion having an interior portion and at least a first end and a second end; a tensioner adapted for attachment to the first end and the second end; and an adjustment mechanism on the exterior portion of the apparatus.

2. The apparatus described in claim 1 wherein said adjustment mechanism changes the flexion of the shaft relative to the tensioner.

3. The apparatus described in claim 1 wherein said adjustment mechanism allows for increased tension on the tensioner mechanism.

4. The apparatus described in claim 1 wherein said apparatus is a golf club

5. The apparatus described in claim 1 wherein said apparatus is a hockey stick.

6. The apparatus described in claim 1 wherein said apparatus is a fishing pole.

7. The apparatus described in claim 1 wherein said shaft has an interior portion and the interior portion is hollow allowing for adaption of the tensioner mechanism therein.

8. The apparatus described in claim 1 wherein tensioner mechanism is constructed of polyethylene.

9. The apparatus described in claim 1 wherein the shaft portion flexion is adjustable relative to the tensioner mechanism rigidity.

10. The apparatus described in claim 1 wherein the shaft portion is flexible and whereby the tensioner mechanism increases and/or decreases the flexibility and flexion of the entire apparatus by adjustment of the individual end user.
